(19) United States
(12) Patent Application Publication
(10) Pub. No.: US 2021/0213933 A1
(43) Pub. Date: Jul. 15, 2021

(54) SYSTEMS, APPARATUS AND METHODS TO IMPROVE PLUG-IN HYBRID ELECTRIC VEHICLE ENERGY PERFORMANCE BY USING V2C CONNECTIVITY

(71) Applicants: THE REGENTS OF THE UNIVERSITY OF CALIFORNIA, Oakland, CA (US); HYUNDAI AMERICA TECHNICAL CENTER INC., Superior Township, MI (US)

(72) Inventors: Francesco Borrelli, Kensington, CA (US); Yongkeun Choi, Berkeley, CA (US); Jacopo Guanetti, Berkeley, CA (US); Yeojun Kim, Berkeley, CA (US); Ryan Miller, Chino, CA (US)

(73) Assignees: THE REGENTS OF THE UNIVERSITY OF CALIFORNIA, Oakland, CA (US); HYUNDAI AMERICA TECHNICAL CENTER INC., Superior Township, MI (US)

(21) Appl. No.: 17/118,320

(22) Filed: Dec. 10, 2020

Related U.S. Application Data
(63) Continuation of application No. PCT/US2019/037154, filed on Jun. 14, 2019.
(60) Provisional application No. 62/685,731, filed on Jun. 15, 2018.

(51) Int. Cl. B60W 20/12; H04W 4/44; B60W 20/11; B60W 20/13

(52) U.S. Cl. CPC B60W 20/12; H04W 4/44; B60Y 2400/214; B60W 20/13; B60W 20/11

(57) ABSTRACT

Systems, apparatus and methods for controlling a plug-in hybrid electric vehicles (PHEVs) to improve energy utilization based on vehicle-to-internet cloud (V2C) connectivity. An automated driving system is trained for predicting vehicle motion trajectories based on historical vehicle and environmental trip data. An automated powertrain control system is trained to provide a parametric approximation of long-term energy cost about the remainder of a given vehicle trip. During the trip the automated driving system plans estimated trajectories based on forecasts of power allocation, while the powertrain control system forecasts and controls the fuel burning engine, electric drive motor(s), and powertrain mode, to minimize energy-wasteful motion trajectories.

### CROSS-REFERENCE TO RELATED APPLICATIONS

This application claims priority to, and is a 35 U.S.C. § 111(a) continuation of, PCT international application number PCT/US2019/037154 filed on Jun. 14, 2019, incorporated herein by reference in its entirety, which claims priority to, and the benefit of, U.S. provisional patent application Ser. No. 62/685,731 filed on Jun. 15, 2018, incorporated herein by reference in its entirety. Priority is claimed to each of the foregoing applications.

The above-referenced PCT international application was published as PCT International Publication No. WO 2019/241612 A1 on Dec. 19, 2019, which publication is incorporated herein by reference in its entirety.

### STATEMENT REGARDING FEDERALLY SPONSORED RESEARCH OR DEVELOPMENT

This invention was made with Government support under Grant Number DE-AR0000791 awarded by the US Department of Energy (DOE). The Government has certain rights in the invention.

### NOTICE OF MATERIAL SUBJECT TO COPYRIGHT PROTECTION

A portion of the material in this patent document may be subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### INCORPORATION-BY-REFERENCE OF COMPUTER PROGRAM APPENDIX

Appendix A referenced herein is a computer program listing in a text file entitled “BK-2018-147-2-US-computer_program_appendix_A.txt” created on Dec. 10, 2020 and having a 17 kb file size. The computer program code, which exceeds 300 lines, is submitted as a computer program listing appendix through EFS-Web and is incorporated herein by reference in its entirety.

### BACKGROUND

### 1. Technical Field

The technology of this disclosure pertains generally to plug-in hybrid electric vehicles (PHEVs), and more particularly to integrated control of longitudinal and powertrain dynamics of plug-in hybrid electric vehicles (PHEVs).

### 2. Background Discussion

During operation of a plug-in hybrid electric vehicle (PHEV), the power requested for vehicle motion and for auxiliary functions is supplied by fossil fuel and electric energy (e.g., obtained from the grid) stored in an on-board battery. PHEVs alleviate many shortcomings of internal combustion engine vehicles and electric vehicles. The on-board battery of the PHEV is connected to one or more electric machines (motors) that can replace or assist the drive engine, as well as regenerate energy during braking. The on-board fuel tank for the combustion engine provides a long driving range and fast refueling for the PHEV unlike the more limited range of electric vehicles. One difference of PHEVs from non-plug-in hybrid electric vehicles is the possibility of recharging the battery from the grid, which allows depleting the battery during a trip toward maximizing use of power stored in the battery thus allowing many PHEVs to drive on electricity for significant distances.

There are additional power demands in a modern vehicle, such as for auxiliary functions that may include on-board sensors, actuators, computational units (processors), lighting, infotainment systems, heating, ventilation, air conditioning, and other desired functions. The power demand for vehicle motion is dictated by the driver or by a system that controls vehicle longitudinal motion. An example system for controlling vehicle longitudinal motion is adaptive cruise control (ACC). ACC is an advanced driver assistance system that automatically adjusts the vehicle speed to maintain a safe distance from the preceding vehicle. ACC systems are widespread in today's vehicles and are mainly oriented to the improvement of passenger safety and comfort.

However, many of these systems are suboptimal, require perfect knowledge for accurate forecasting of future power demands, require large computational resources, and/or require simulations over a variety of driving conditions to empirically verify tuning solutions.

Accordingly, a need exists for improved systems and methods for improving PHEV energy utilization. The present disclosure fulfills that need and provides additional benefits over previous technologies.

### BRIEF SUMMARY

This disclosure describes systems, apparatus and methods for integrated control of longitudinal and powertrain dynamics of plug-in hybrid electric vehicles (PHEVs) which enable energy efficient and safe adaptive cruise control (ACC). It should be appreciated, however, that the present disclosure is applicable to other hybrid vehicle architectures.

The PHEV comprises a fuel burning engine, an electric motor(s), a battery system, a clutch coupling between the engine and the electric motor(s), a drive transmission for coupling mechanical output from the engine and/or electric motor(s) to a drivetrain. Power requested for vehicle motion is supplied by a combination of the engine in response to burning fuel and the electric motor(s) operating from stored energy in the battery system.

Power use by the PHEV is controlled by a data driven supervisory energy management system (EMS) which has a number of characteristics. (a) An automated driving system is trained to provide a prediction process for vehicle motion trajectories and output environmental prediction parameters based on vehicle and trip related environmental factors. By way of example the vehicle and trip related environmental factors comprise historical vehicle trip data including vehicle speed, preceding vehicle speed and relative distance, as well as sensor information about the vehicle and the environmental state. (b) An automated powertrain control system is trained to generate parametric approximations of a cost function to reach a destination, such as in response to historical trip data, and cloud-based traffic data, as well as information about vehicle and powertrain state. The parametric approximations provide long-term estimations about the remainder of a given trip of the PHEV as trip energy cost parameters. (c) An automated driving system which utilizes the environmental prediction parameters, in combination with information about vehicle and environmental state, to forecast power allocation for planning an estimated trajectory while avoiding energy-wasteful behaviors. (d) A powertrain control system configured for outputting forecasts of power allocation based on trip energy cost parameters, information about vehicle and powertrain state, and for controlling torque of the fuel burning engine and the electric motor(s), as well as for controlling powertrain mode.

Further aspects of the technology described herein will be brought out in the following portions of the specification, wherein the detailed description is for the purpose of fully disclosing preferred embodiments of the technology without placing limitations thereon.

### BRIEF DESCRIPTION OF THE SEVERAL VIEWS OF THE DRAWING(S)

The technology described herein will be more fully understood by reference to the following drawings which are for illustrative purposes only:

FIG. 1 is a block diagram of an embodiment of the control architecture of the presented technology, according to an embodiment of the present disclosure.

FIG. 2 is a block diagram of a typical PHEV architecture having an ECU in which control is performed according to an embodiment of the present disclosure.

FIG. 3 is a flowchart of a longitudinal control system operation performed according to an embodiment of the present disclosure.

FIG. 4 is a block diagram of a general vehicle control architecture according to an embodiment of the present disclosure.

FIG. 5 is a block diagram of adaptive cruise control (ACC) according to an embodiment of the present disclosure.

FIG. 6 is a plot comparing simulated velocity profiles between the preceding vehicle and ego vehicle according to an embodiment of the present disclosure.

FIG. 7A and FIG. 7B illustrate plots of state-of-charge (SOC) and consumed fuel in comparing energy consumption between baseline PHEV operation and PHEV operation according to an embodiment of the present disclosure.

### DETAILED DESCRIPTION

### 1. Introduction

Recent research has shown that longitudinal control systems, including Adaptive Cruise Control (ACC), can significantly affect vehicle energy performance. In these systems the control policy often solves, in an approximated manner, an optimal control problem, where the goal is to minimize the energy consumption for vehicle motion, subject to dynamic constraints, safety constraints such as collision avoidance, and boundary conditions such as trip length and duration. In real-world deployments, longitudinal control systems such as ACC can greatly benefit from a preview or prediction of the preceding vehicle speed trajectory.

Any PHEV implements an energy management system (EMS), that in real-time allocates the current power demand from the on-board power sources. A primary goal in EMS design is energy efficiency, which is achieved by intelligently balancing the use of fuel and electric energy in order to maximize trip-wise efficiency. A major issue is that the electric energy stored on-board is limited, and battery recharge is time consuming. To overcome the energy storage issue an optimal (or close to optimal) EMS policy requires perfect knowledge (an accurate forecast) of the future power demand, throughout the trip. In practice, accurate forecasts can be expensive or difficult to determine, and often require additional user involvement, for instance in regard to planning the route and associated charging station stops.

A simple attempt around these complications was the so-called Charge Depleting-Charge Sustaining (CD-CS) strategy. According to CD-CS the vehicle is mostly operated with electricity (CD phase) until the state of charge (SOC) of the battery reaches a minimum limit, and afterwards it is mostly operated on gasoline, maintaining the battery charge to the selected minimum level (CS phase). In the CD phase, the internal combustion engine can still be used when the requested power exceeds the limits of the electric machines. In the CS phase, the electric machines may be used to boost the engine or perform energy regeneration, under the condition that, on average, the battery charge is maintained at the same level.

Many systematic approaches for designing an EMS are based on optimal and predictive control ideas. Assuming that the power demand throughout the trip is perfectly known, the optimal EMS policy can be determined solving an optimal control problem. While there is no known analytical solution to this problem, various numerical approaches have been proposed. These methods show that the CD-CS strategy explained above is in general suboptimal; the optimal policy requires using both fuel and electric power in a blended manner throughout the trip, making use of the full knowledge of the power demand. Since the power demand is only known in real-time, an approach needs to be taken to bridge this information gap.

One possible approach is the building of a stochastic model of the power demand, for instance by training a Markov chain using historical profiles of the power demand. Finding the optimal EMS policy then becomes a stochastic optimal control problem, which can be solved by stochastic dynamic programming (SDP) techniques. A disadvantage of this approach is the large computational effort required to solve SDP. On the positive side, this computation only needs to be performed once and offline, with the optimal policy stored in the form of a look up table for use in real-time. On the negative side, this workflow is inconvenient when the model needs to be retrained (relatively) frequently, when new driving data becomes available. One mechanism for circumventing this issue is to incorporate system learning, in such a way that a personalized policy can be learned over time. This can be achieved through stochastic model predictive control (SMPC). Because the SMPC problem is solved in real time, the stochastic part of the model can also be learned in real time, as driving data become available. A limitation of this approach is the large computational effort required in real time.

Another type of approach is in systematically using the available data and incorporating learning in the powertrain control as approximate dynamic programming (ADP). Recent work in ADP investigated this possibility for a PHEV, with an algorithm that attempted to learn optimal EMS policy using data of vehicle speed, road grade, battery charge, power demand, and availability of charging stations. ADP is appealing because most computational effort is moved offline, and learning can be naturally incorporated.

To mitigate computational requirements, a popular direction is to use a locally optimal control policy, and to expose one or more tuning ‘knobs’ (usually weights in the cost function), and then various adaptation and estimation approaches are used to modulate the knobs during real-time operation. A well-known example is the equivalent consumption minimization strategy (ECMS) with its adaptive variants. ECMS achieves global optimality by: (1) minimizing, at each time step, a function of the current states, power request, and of a global parameter (constant along the trip), and (2) iteratively refining the value of the global parameter, until convergence is achieved to an optimal value. Several real-time approaches utilize the same local minimization policy, and use various techniques to compute a reasonable value of the global parameter. These techniques use past values of the power request and/or forecasts of the driving cycle, or track a global reference for the battery energy. While in practice these methods can provide usable results in some driving conditions, there are no guarantees on performance or on the satisfaction of the battery charge constraints. In practice, this method requires simulations or experiments in a variety of driving conditions, to verify empirically that the selected tuning achieves satisfactory performance.

In view of the above limitations for these approaches, we have developed a new control paradigm.

### 2. Vehicle-to-Cloud (V2C) EMS for PHEVs

Systems, apparatus and methods are disclosed for performing integrated control of longitudinal and powertrain dynamics of plug-in hybrid electric vehicles (PHEVs) which enable energy efficient and safe adaptive cruise control (ACC). Enabled by the recent developments in vehicle-to-cloud (V2C) connectivity, the presented technology comprises a new data driven supervisory energy management system (EMS) for PHEVs.

By way of example, and not of limitation, the presented technology includes systems, apparatus and methods to control the longitudinal motion and the powertrain of a PHEV in a coordinated manner, and to use historical trip data, traffic data services, and cloud computations to train the on-board control system (for both longitudinal motion and powertrain control) from this data. The goal of cloud-based training is to improve the energy performance over time as data are collected, despite traffic uncertainties and other factors, including load and weather. The real-time on-board controllers communicate with the cloud-based offline training process through V2C communication.

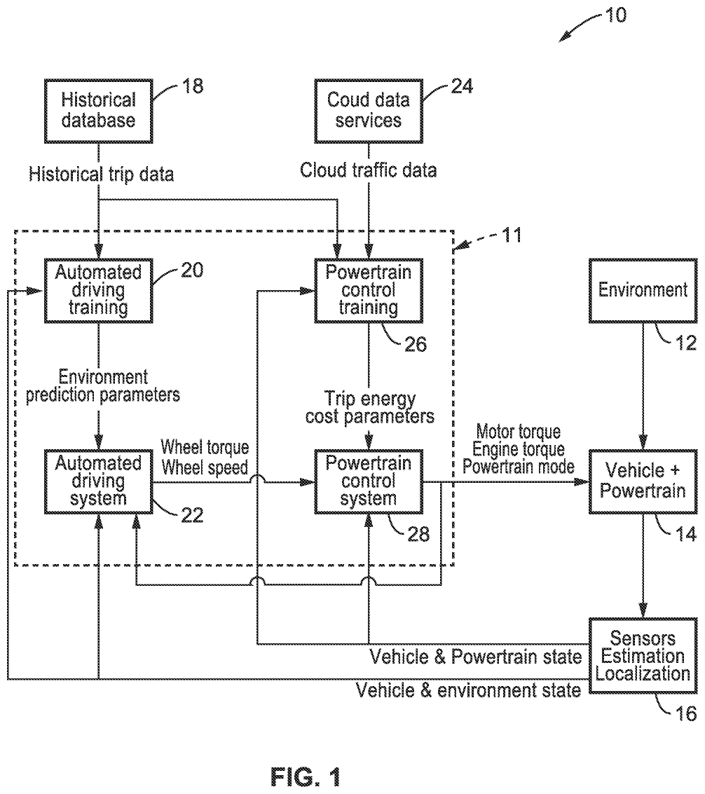

FIG. 1 illustrates an example control architecture embodiment 10 of a PHEV EMS using V2C connectivity. The control elements 11 of the present disclosure include automated driving training module 20, automated driving system module 22, powertrain control training module 26 and a powertrain control system module 28. These elements are seen interacting with a historical database 18, cloud data services 24, while elements of the PHEV and its environment are depicted as environment 12, vehicle and powertrain 14, and information from a sensor suite providing sensor, estimation and localization information 16.

2.1. Using Data to Improve PHEV Energy Performance

In the embodiment shown in FIG. 1, data is used for improving energy performance as described below.

2.1.1. Automated Driving Training

The automated driving training module 20 uses data, including historical trip data from historical trip database 18, to train a prediction algorithm of the front vehicle (preceding vehicle) trajectory. The training data includes at least ego vehicle speed, preceding vehicle speed, and relative distance. Training improves the accuracy in the real-time prediction of the behavior of a vehicle in-front, which is a major source of uncertainty when performing real-time control. Reducing vehicle in-front uncertainties can reduce energy-wasteful behaviors, which can include braking, excessive accelerations, and other suboptimal energy management strategies. Automated driving training module 20 outputs environmental prediction parameters to an automated driving system module 22.

2.1.2. Powertrain Control Training. The powertrain control training module 26 uses data, including at least historical trip data from historical database 18, and traffic data from cloud data services 24, to learn a parametric approximation of the (energy) cost to reach the destination. This approximation is used by the on-board powertrain control system in real-time, as a compressed representation of long-term information about the remainder of the trip. In this way the on-board real-time powertrain control system can provide workable approximations spanning a long trip period (long-sighted), while only performing low-complexity local optimization in real time. Powertrain control training module 26 outputs trip energy cost parameters to the powertrain control system 28.

2.1.3. Automated Driving System. The automated driving system module 22 uses the trained prediction, from automated driving training module 20, along with vehicle and environmental state information from sensors, estimation and localization 16 to plan its future trajectory, toward avoiding energy-wasteful behaviors; which for instance include excessive braking, accelerations and other actions leading to suboptimal energy management. The automated driving system also utilizes forecasts of power allocation from the powertrain control system, to improve cost estimates for planned maneuvers. Automated driving system module 22 outputs signals for wheel torque and speed to powertrain control system 28.

2.1.4. Powertrain Control System. The powertrain control system module 28 receives information on vehicle and powertrain state from sensors 16, trip energy cost parameters from powertrain control training module 26 that are used in combination with forecasts of the power demand (wheel torque and speed) as received from the automated driving system module 22 to reduce uncertainty due to the immediate surrounding traffic. It will be noted that using the information about the power demand in the immediate future reduces the chance of energy-wasteful behaviors. Powertrain control system module 28 outputs signals to the vehicle and its powertrain 14. These control signals are exemplified in the figure as controlling motor torque, engine torque and powertrain mode.

2.2. PHEV Requirements

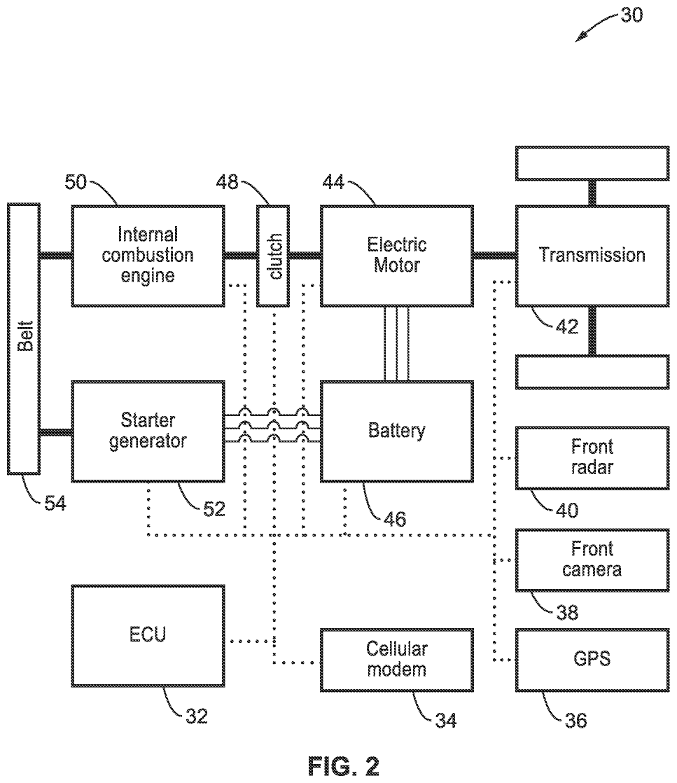

FIG. 2 illustrates an example embodiment 30 of a PHEV architecture instrumented for at least level 1 automated driving, to which the disclosed ECM apparatus is applied by way of example and not limitation. In the figure, mechanical interconnection between the blocks are represented by thick lines, electrical interconnections are depicted with thin triple lines, and communication interconnections are shown with thin dashed lines.

The figure depicts an electronic control unit (ECU) 32, cellular modem 34, global positioning system (GPS) 36, front camera 38, front radar 40, transmission 42, electric motor(s) 44, battery 46, clutch 48, internal combustion engine 50, starter generator 52 and belt 54. Mechanical connections are seen between engine 50, belt 54, starter-generator 52 and through clutch 48 to electric motor 44 and to transmission 42 having drive wheels 43. Power connections are seen between starter-generator 52 to battery 46 and to the electric motor 44. It will be noted that the majority of significant PHEV components are preferably interconnected by communications signals for control and monitoring purposes.

It should be appreciated that although a number of the control operations are described as being performed in the electronic control unit (ECU) 32, these operations may be distributed or alternatively performed, without limitation, in one or more other control modules that interoperate with the ECU.

### 3.0. ECU Control Process Example

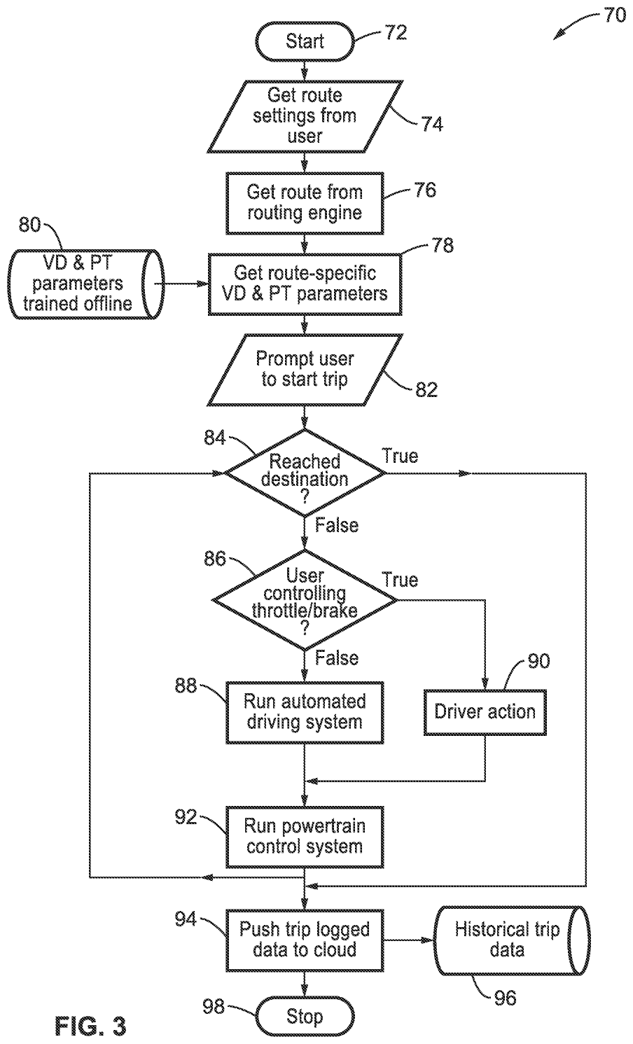

FIG. 3 illustrates an example embodiment 70 of on-board software, for example executing from the electronic control unit (ECU) block of FIG. 2, which is executing real time processes. Not represented in the flowchart is the training process, which is run offline in the cloud, as new data becomes available.

In particular, the example figure depicts process start 72 followed by obtaining route settings 74 from the user, and obtaining the route from a routing engine. In step 78 route specific vehicle dynamics (VD) and powertrain (PT) parameters are obtained 80 from offline training. The user is prompted 82 to start the trip, after which periodic checks 84 are performed to determine if the user has reached the destination. If the destination is not yet reached then a check is made at block 86 which determines if the user is controlling the throttle and braking. If the user is in control, then this throttle and braking are in response to driver action 90. Otherwise, an ACC is operating which runs an automated driving system 88. This data is used to run 92 the powertrain control system, and a return is made to block 84 to check trip progress toward the destination. If the destination is reached, then execution moves to block 94 at which time the logged data over the trip is pushed to the cloud with historical trip data being recorded 96 and the process ending 98. It should be appreciated that the term “cloud” or “cloud computing” refers to the Internet, and more particularly to a datacenter containing internet servers which execute software services associated with the PHEV operations described herein.

In at least one embodiment, the on-board control system executes (runs) in real-time and includes an automated driving system and a powertrain control system. In at least one embodiment, the automated driving system includes an environmental prediction block and a longitudinal control block. In one embodiment, the environmental prediction provides a longitudinal control block with velocity prediction of preceding vehicles. In at least one embodiment, this velocity prediction is in the form of an equally spaced discrete time series, where the prediction at each time step affects subsequent predictions. For this reason, rather than the commonly used constant velocity/acceleration model, a non-linear autoregressive recurrent neural network can be utilized, for example being trained using historical trip data.

3.1. Example 1 of Utilizing Model Predictive Control

In at least one embodiment, the longitudinal control can be implemented using model predictive control, solving at each time step the following problem:

$${min}_{{u}_{0} , … , {u}_{N - 1}} {\sum }_{k = 0}^{N} ‖ {v}_{k} - {v}_{d} ‖ + {\sum }_{k = 0}^{N - 1} ‖ {E}_{p} ( {v}_{k} , {u}_{a , k} , {α}_{k} ) ‖ + {\sum }_{k = 0}^{N - 1} ‖ {u}_{b , k} ‖ \\ s . t . {x}_{0} = {x}_{t} \\ \begin{matrix}{x}_{k + 1} = f ( {x}_{k} , {u}_{k} , {d}_{k} ) \\ {x}_{k} ∈ X , {u}_{k} ∈ U\end{matrix} \} k = 0 , … , N - 1$$

$${x}_{N} ∈ S$$

wherein:

(a) subscript k represents the discrete time step in the prediction horizon, N is the length of the prediction horizon, t is the current time;

(b) state x includes the vehicle speed v and the distance to the preceding vehicle d;

(c) input u includes the accelerating wheel torque uₐ and the braking wheel torque u_{b};

(d) cost function penalizes:
(i) deviations from a reference velocity v_{d} (defined manually by the driver or by the preceding vehicle, if any);
(ii) estimated powertrain energy consumption Eₚ(vₖ, u_{a,k}, αₖ a weighted sum of battery energy and fuel energy; Eₚ is a function of the vehicle speed v, of the accelerating torque u_{b}, and of the torque allocation ratio α=Tₘ/Tₑ (Tₘ is the motor torque, Tₑ is the engine torque) predicted by the powertrain control system at the previous time step; and
(iii) braking torque u_{b};

(e) state dynamics f can be defined by the longitudinal vehicle dynamics;

(f) state constraints X include safety constraints, such as a minimum distance to preceding vehicle, and speed limits;

(g) input constraints U include actuator limits such as tire friction limits and powertrain limits; and

(h) robust invariant set S guarantees persistent feasibility, for example the persistent existence of a safe control input even after the prediction horizon N.

Let [u₀*, . . . , u_{N-1}*]^{T} be the solution at time t=t̅; the first input u₀* is transmitted to the powertrain control system at time t=t̅. At the next time step t=t̅+Δt (Δt is the time step between two subsequent calls to the automated driving system), the optimization problem above is solved using the new vehicle states xₜ. The MPC control law is given by uₜ=u₀*.

3.2. Example 2 of Utilizing Model Predictive Control

In at least one embodiment, the powertrain control system can be implemented utilizing model predictive control, solving at each time step the following problem:

$${min}_{{u}_{0} , … , {u}_{N - 1}} {\sum }_{k = 0}^{N} ( α {P}_{f} ( {x}_{k} , {u}_{k} , {w}_{k} ) + β {P}_{q} ( {x}_{k} , {u}_{k} , {w}_{k} ) ) + {\hat{J}}_{N} ( {x}_{n} , {r}_{n} ) \\ s . t . {x}_{0} = {x}_{t} \\ \begin{matrix}{x}_{k + 1} = f ( {x}_{k} , {u}_{k} , {w}_{k} ) \\ 0 = h ( {x}_{k} , {u}_{k} , {w}_{k} ) \\ {x}_{k} ∈ X , {u}_{k} ∈ U\end{matrix} \} k = 0 , … , N - 1$$

$${x}_{N} ∈ {X}_{N}$$

where:

(a) subscript k represents the discrete time step in the prediction horizon, N is the length of the prediction horizon, t is the current time;

(b) state x includes the battery internal energy state of charge and the engine state;

(c) value of input u includes the engine torque, motor torque and engine switch;

(d) disturbance w includes the wheel speed and torque;

(e) cost function penalizes a weight sum of fuel power P_{f} and battery internal power P_{q}, that are non-linear mappings of the states, inputs and disturbances;

(f) state dynamics f includes the battery charge dynamics;

(g) algebraic constraints h include the mechanical and electrical couplings between the powertrain components;

(h) state constraints X, X_{N} include battery safe operation constraints, such as state of charge limits;

(i) input constraints U include actuator limits, such as electric motor torque limits and internal combustion engine torque limits.

At time t=t̅, [u₀*, . . . , u_{N-1}*]^{T} is the solution to the problem above: the first input u₀* is transmitted to the vehicle powertrain, and the remainder of the sequence [u₁*, . . . , u_{N-1}*]^{T} is transmitted to the automated driving system. At the next time step t=t̅+Δt (Δt is the time step between two subsequent calls to the powertrain control system), the optimization problem above is solved using the new vehicle states xₜ. The MPC control law is given by uₜ=u₀*.

3.3. Other Example Control Embodiments

In at least one embodiment, the powertrain control system communicates the power allocation forecast for the shifted horizon to the longitudinal control.

In at least one embodiment, a cloud training service is provided that includes an automated driving training service and a powertrain control training service.

In at least one embodiment, the automated driving training service can be implemented as follows. During or at the end of every trip, the velocity trajectories of the ego vehicle and of the preceding vehicles are pushed and stored in the cloud. Given a set of logged trip data, a non-linear autoregressive recurrent neural network is trained using the stochastic gradient descent back propagation. To avoid overfitting on the data, cross validation is used. At the beginning of each trip, an updated neural network (in the form of updated neuron weights) is sent to the environmental prediction block in the automated driving system.

In at least one embodiment, powertrain control training can be implemented as follows. The approximated cost-to-go function can be taken to be a linear function of m features ϕ_{l,k} associated to the current system state xₖ, and of m weights r_{l,k}, l=1, . . . , m:

$${\hat{J}}_{k} ( {x}_{k} , {r}_{k} ) = {\sum }_{1 = 1}^{m} {r}_{l , k} {ϕ}_{, , k} ( {x}_{k} )$$

During powertrain control training, the index k denotes the position along the route. The system state xₖ includes powertrain states such as battery charge, vehicle states such as time since departure, speed, acceleration, and environment states such as traffic speed and time of day. The quality of the approximation Jₖ*(xₖ)≈Ĵₖ(xₖ,rₖ) depends on the choice of the feature vector ϕₖ(xₖ)=[ϕ_{l,k}(xₖ), . . . , ϕ_{m,k}(xₖ)]^{T}. The feature vector may include: the current battery charge and the remaining battery charge until destination; the fuel used since departure; the time since departure and to destination; average speed of the vehicle, average speed of the traffic, and the difference of the average speeds; the location and availability of charging stations at the destination and/or along the route; driving patterns such as the average, minimum and maximum acceleration, and so forth.

Once a set of features is defined, the powertrain control training optimizes the weights rₖ according to the available training data (state space samples), xₖ^{s}, s=1, . . . , q. The weights can be determined, such as by fitted value iteration, for example solving a least squares problem at each time step, minimizing the error in satisfying the dynamic programming equation at step k. The training algorithm can proceed backwards from the trip destination to its origin, for example from k=N to k=0):

$${r}_{k} = arg {min}_{r} {\sum }_{s = 1}^{q} {( {\hat{J}}_{k} ( {x}_{k}^{s} , r ) - {β}_{k}^{s} )}^{2}$$

where, at step k, βₖ^{s} is the known scalar

$${β}_{k}^{s} = {min }_{u ∈ {U}_{k} ( {x}_{k}^{s} )} E \{ g ( {x}_{k}^{s} , u , {w}_{k} ) + {\hat{J}}_{k + 1} ( {f}_{k} ( {x}_{k}^{s} , u , {w}_{k} ) , {r}_{k + 1} ) \}$$

in which E denotes the expectation, f denotes the system dynamics, u denotes the control variables and w denotes the disturbance variables, such that xₖ₊₁=fₖ(xₖ, uₖ, wₖ). For powertrain control training, the control variables include engine torque, motor torque, and clutch state.

Since Ĵₖ(ϕₖ(xₖ), rₖ) is linear in the weights, the least squares problem that determines rₖ can be solved analytically; this positively affects the speed and complexity of the training process. A nonlinear structure of Ĵₖ(ϕₖ(xₖ), rₖ) is possible as well, for example using neural networks; and although the corresponding approximation result may be more accurate the training process becomes more complicated as the computation of each rₖ requires the solution of a nonconvex optimization problem. The sample data xₖ^{s} can be generated both by measuring driving data, preferably including traffic and environment data, and by performing simulations, which may include real-world traffic data using a simulated vehicle and powertrain, while the traffic process may also be simulated.

In at least one embodiment, the training procedure is performed (run) offline when new samples are available, to incorporate learning and adaptation. A trade-off exists between learning (improvement of performance) and overhead (offline computational load), which has to be evaluated based on data and experiments. When a trip is ongoing, the weights rₖ and a part of the features ϕ_{l,k}(xₖ) which are related to traffic state are communicated to the vehicle in real time using V2C communication. The communication can be performed for example in a batch manner, with all vectors communicated at the beginning of the trip, or as the vehicle travels along the route with the vehicle communicating its current position and the cloud transmitting the relevant vectors.

3.4. Summary of General Control Operations

In at least one embodiment, the system operates as follows:

1. Before the trip begins, a user interface session is performed, comprising the steps: (a) displaying current position of the vehicle, such as retrieved from the GPS, and the current battery charge state, such as retrieved from the vehicle bus; (b) setting current position as the default trip origin and the default charge at destination to the minimum value; (c) allowing the user to modify the trip origin, as desired, to specify the trip destination, to specify route constraints such as desired departure time, desired arrival time, desired battery charge at destination, desired number of stops at charging stations before arrival, combinations thereof and so forth; and (d) prompting the user to confirm the settings when at least the trip origin has been entered.

2. Transmitting the user settings entered from the user interface session to a routing service which returns the route in the form of a set of selected route waypoints.

3. Connecting to a cloud training service and extracting control parameters based on a combination of the selected route waypoints, the user settings, and on the current conditions of the vehicle and the environment for the selected route.

4. Prompting the user for confirmation of the above and to initiate (start) the trip.

5. Performing the following steps, at any time after the trip has been initiated: (a) activating, in response to driver input, the automated driving system, such as by the driver activating a control (e.g., pushing a button on the steering wheel); (b) assuming vehicle longitudinal motion control by the automated driving system after its activation; (c) tracking minimum speed by the automated driving system from the speed limits comprising: (i) speed limit in the current road segment, (ii) desired speed set by the driver, and (iii) measured speed of the preceding vehicle; (d) utilizing environmental predictions in making decisions within the automated driving system, wherein environmental predictions comprise front (preceding) vehicle speed predictions which are tuned using parameters determined by the cloud-based training procedure; and (e) disengaging the automated driving system in response to: (i) the driver deactivating (turning off) the automated driving system; or (ii) the driver taking over control of the vehicle; or (iii) when the system determines that the requirements for safe operation are not being met.

6. The powertrain control system becomes active and remains active until the selected destination is reached with the initial trained parameters. Pushing updated parameters for the cost function to the vehicle in response to the cloud service monitoring route, vehicle state, powertrain state, live traffic and traffic forecast along the route. The updated parameters for example are a function of various factors, including the specific road segment being traversed and the current and predicted traffic state.

7. Gathering vehicle and powertrain measurements logged throughout the trip and pushing them to a cloud repository using V2C communication at the end of the trip.

8. Performing offline operations, including communicating with the cloud training service when new data becomes available, for example new data can include new logged trips and new samples of traffic data from cloud traffic information services.

### 4.0. General Architecture and Operation

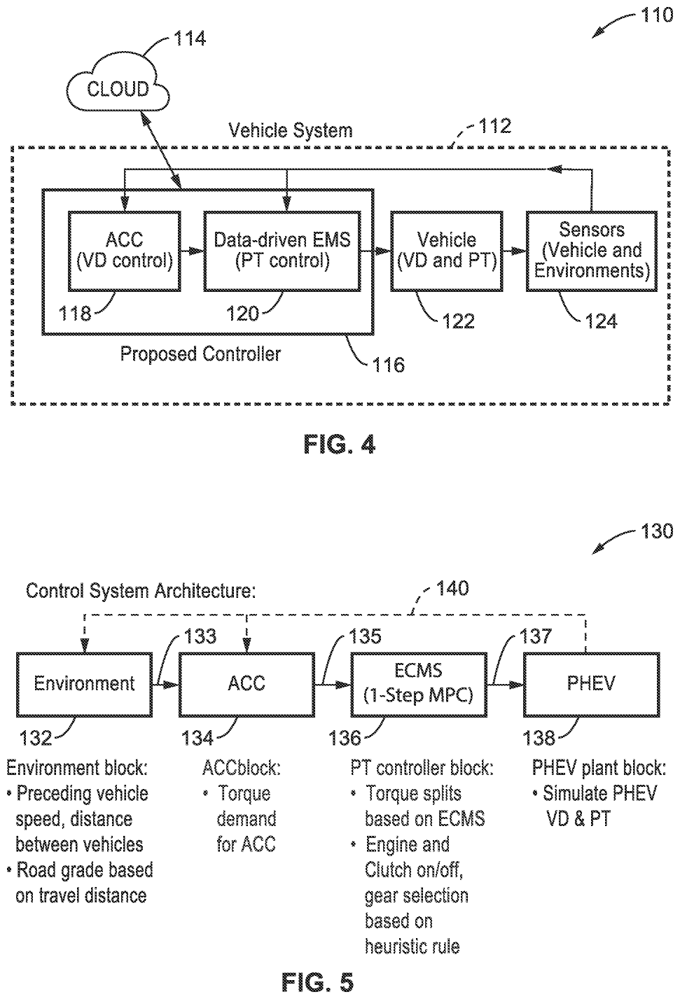

FIG. 4 illustrates an example embodiment 110 of a general control architecture for the technology, showing vehicle system 112 in relation to Internet ‘cloud’ resources 114, in which servers operating on the internet perform service operations according to the present disclosure.

Vehicle system 112 is shown having the disclosed controller 116 comprising an adaptive cruise control (ACC) 118 for vehicle dynamics (VD) control and a data-driven EMS 120 for powertrain (PT) control. Controller 116 generates outputs to the vehicle systems 122 for VD and PT control. Sensors 124 (vehicle and environment) are configured to: (i) measure the response of vehicle systems 122 to the outputs of controller 116, and (ii) to perceive the surrounding environment. The sensors 124 are connected in a feedback loop to ACC 118 and EMS 120 in controller 116. Controller 116 is also connected to the cloud-based server 114 though a conventional wired or wireless Internet connection.

In at least one embodiment, the ACC system pursues energy efficiency by adjusting vehicle speed based on projected trip estimations, while maintaining at least equivalent safety and comfort as the production system.

In at least one embodiment, the PHEV powertrain EMS pursues energy efficiency by optimizing the allocation of power demand, between the electric motor and the internal combustion engine and the depletion of battery charge throughout the trip, in response to historical trip data.

In at least one embodiment, the ACC controller seeks to improve energy performance by utilizing appropriately formulated model predictive control to minimize total energy consumption. Consequent power demand is then communicated to the powertrain controller. The tuning of the powertrain controller is based on historical driving data, collected on various routes and including vehicle states, powertrain measurements, and environmental conditions, for example traffic conditions, weather information, Global Positioning System (GPS) coordinates, and other conditions relevant to the vehicle and its routing path. Once the driver sets (e.g., enters, communicates, modifies) the desired destination, a pre-computed cost-to-go parameters, which is also based on the current state-of-charge (SOC) of the vehicle, is pushed to the powertrain controller. Through V2C connectivity, the cloud pushes pre-computed cost-to-go parameters to the vehicle online so that it can adapt to the new routes. If the trip length is within EV range, and additional auxiliary power is assumed not to be used, the disclosed EMS system operates in a similar manner to a charge depleting-charge sustaining (CD-CS) strategy, and thus provides similar energy efficiency. Otherwise, utilizing the present disclosure provides improved energy performance compared to current technologies.

In at least one embodiment, the system operates as follows:

1. Establishing vehicle destination, for example by the driver indicating (e.g., inputting, communicating and/or modifying destination) to the vehicle system.

2. Connecting the vehicular system through a communications connection to an internet based cloud service (V2C) configured for extracting control parameters for the vehicular system based on current vehicle conditions and environment for a specific route to be traversed by the vehicle.

3. Activating a data driven supervisory EMS of the vehicular system with a set of control parameters.

4. Accepting control of vehicle longitudinal dynamics (VD) by the ACC system upon the driver activating the designed ACC system, wherein the vehicle autonomously tracks desired speed set by the driver, and adapts its speed based on the preceding vehicle velocity and road grade predictions given from V2C connectivity.

5. Terminating operation of the ACC system when either it is disabled by the driver, or upon the ACC system determining its use is no longer applicable.

6. Operating the powertrain controller throughout vehicle operations along the route with continuing updates of the control parameters from V2C connectivity.

4.1. ACC Simulation Example

FIG. 5 illustrates an example embodiment 130 of an ACC simulation developed for the present disclosure. By way of example and not limitation, the simulation is described for running in the MATLAB environment. The Environment block 132 tracks preceding vehicle speed, distance between vehicles, and road grade based on travel distance and generates output 133. The ACC block 134 manages torque demand for the ACC and generates output 135. An equivalent consumption minimization strategy (ECMS) block 136 is shown which provides powertrain (PT) control by managing torque splits based on ECMS information, controlling engine and clutch state (on/off), controlling gear selection based on heuristic rule(s), and generating control outputs 137. In at least one embodiment the ECMS comprises a 1-step MPC 136 which provides powertrain (PT) control by allocating the torque demand from ACC, controlling engine and engine state (on/off), controlling gear selection based on heuristic rule(s), and generating control outputs 137. A PHEV block 138 simulates PHEV vehicle dynamics (VD) and vehicle powertrain (PT), and outputs signals 140 to the environmental 132 and ACC blocks 134.

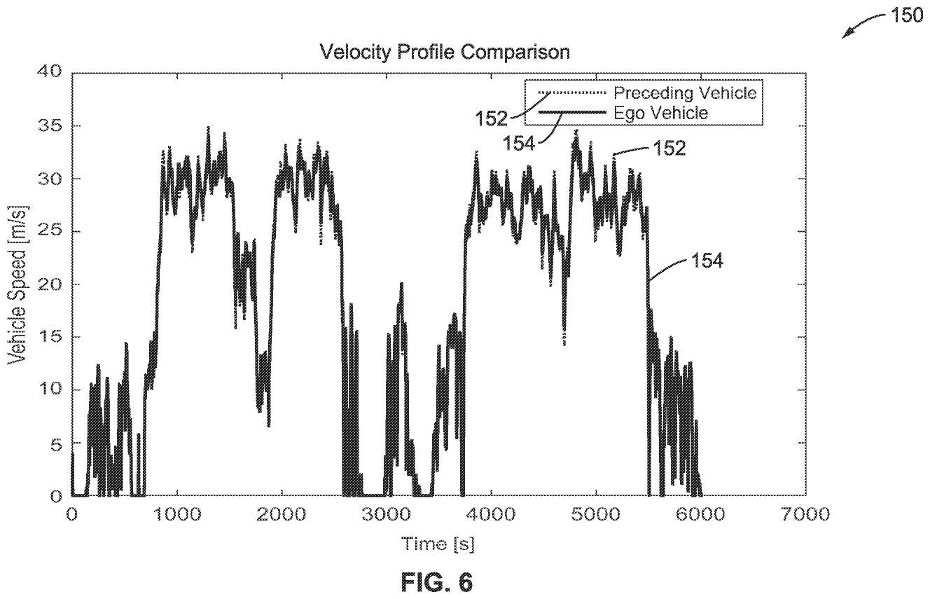

FIG. 6 illustrates an example velocity profile 150 showing a comparison between operation of the preceding vehicle 152 and the ego vehicle 154, depicting a substantial overlap in these velocity profiles.

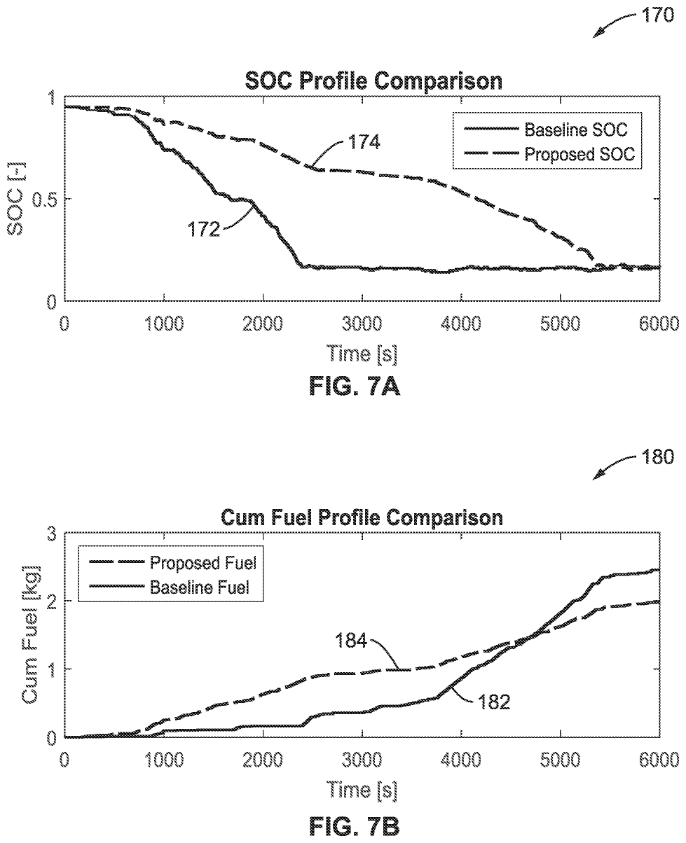

FIG. 7A and FIG. 7B illustrate state-of-charge (SOC) 170 and fuel use 180 comparisons between the baseline 172, 182 and the controller 174, 184 according to the present disclosure. The simulation indicates a total savings of about 20% in response to utilizing the ACC of the present disclosure.

4.2. ACC Simulation Example

A number of tables in Appendix A (computer program appendix) provide various code segment examples for the present disclosure. It should be appreciated, however, that the teachings of the present disclosure are not limited to being practiced according to these code examples.

Table 1 contains an embodiment of code “DP_Main.m” which computes the optimal powertrain policy for one historical trip dataset, using a dynamic programming approach. Table 2 contains an embodiment of code “PT_Model.m” which is the powertrain model used in the dynamic programming of Table 1. Table 3 contains an embodiment of code “trainValFn.m” which trains parameters used for cost-to-go approximation. Table 4 contains an embodiment of code “vd_model.m” which is a vehicle dynamics model. Table 5 contains an embodiment of code “PT_MPC.m” which is a real time powertrain controller using 1-step MPC and the model of Table 2. Table 6 contains an embodiment of code “ACC.m” which is an ACC for VD control, based on MPC and the model of Table 4. To run the ACC simulation example, one first needs to load all necessary parameters (such as vehicle parameters) and route data. Then one needs to run Table 1 for all the available historical driving cycles and run Table 3 to obtain the parameters for cost-to-go approximation. Finally, the code in Table 6, Table 5, Table 2, and Table 4 is executed at each time step of the simulation until the end of driving cycle.

### 5. General Scope of Embodiments

The enhancements described in the presented technology can be readily implemented within various plug-in hybrid electric vehicles (PHEVs) and associated servicing applications, at least a portion of these serving applications operate over the internet, such as in vehicle-to-cloud (V2C) mode, as cloud based internet services. It should also be appreciated that vehicle control and servicing applications (e.g., internet based service applications) are preferably implemented to include one or more computer processor devices (e.g., CPU, microprocessor, microcontroller, computer enabled ASIC, neural processor, etc.) and associated memory storing instructions and state information (e.g., RAM, DRAM, NVRAM, FLASH, computer readable media, etc.) whereby programming (instructions) stored in the memory are executed on the processor(s) to perform the steps of the various process methods described herein.

The computer and memory devices were not depicted in the diagrams for the sake of simplicity of illustration, as one of ordinary skill in the art recognizes the use of computer devices for carrying out steps involved with PHEV control and application services to support PHEV control. The presented technology is non-limiting with regard to memory and computer-readable media, insofar as these are non-transitory, and thus not constituting a transitory electronic signal.

Embodiments of the present technology may be described herein with reference to flowchart illustrations of methods and systems according to embodiments of the technology, and/or procedures, algorithms, steps, operations, formulae, or other computational depictions, which may also be implemented as computer program products. In this regard, each block or step of a flowchart, and combinations of blocks (and/or steps) in a flowchart, as well as any procedure, algorithm, step, operation, formula, or computational depiction can be implemented by various means, such as hardware, firmware, and/or software including one or more computer program instructions embodied in computer-readable program code. As will be appreciated, any such computer program instructions may be executed by one or more computer processors, including without limitation a general purpose computer or special purpose computer, or other programmable processing apparatus to produce a machine, such that the computer program instructions which execute on the computer processor(s) or other programmable processing apparatus create means for implementing the function(s) specified.

Accordingly, blocks of the flowcharts, and procedures, algorithms, steps, operations, formulae, or computational depictions described herein support combinations of means for performing the specified function(s), combinations of steps for performing the specified function(s), and computer program instructions, such as embodied in computer-readable program code logic means, for performing the specified function(s). It will also be understood that each block of the flowchart illustrations, as well as any procedures, algorithms, steps, operations, formulae, or computational depictions and combinations thereof described herein, can be implemented by special purpose hardware-based computer systems which perform the specified function(s) or step(s), or combinations of special purpose hardware and computer-readable program code.

Furthermore, these computer program instructions, such as embodied in computer-readable program code, may also be stored in one or more computer-readable memory or memory devices that can direct a computer processor or other programmable processing apparatus to function in a particular manner, such that the instructions stored in the computer-readable memory or memory devices produce an article of manufacture including instruction means which implement the function specified in the block(s) of the flowchart(s). The computer program instructions may also be executed by a computer processor or other programmable processing apparatus to cause a series of operational steps to be performed on the computer processor or other programmable processing apparatus to produce a computer-implemented process such that the instructions which execute on the computer processor or other programmable processing apparatus provide steps for implementing the functions specified in the block(s) of the flowchart(s), procedure (s) algorithm(s), step(s), operation(s), formula(e), or computational depiction(s).

It will further be appreciated that the terms “programming” or “program executable” as used herein refer to one or more instructions that can be executed by one or more computer processors to perform one or more functions as described herein. The instructions can be embodied in software, in firmware, or in a combination of software and firmware. The instructions can be stored local to the device in non-transitory media, or can be stored remotely such as on a server, or all or a portion of the instructions can be stored locally and remotely. Instructions stored remotely can be downloaded (pushed) to the device by user initiation, or automatically based on one or more factors.

It will further be appreciated that as used herein, that the terms processor, hardware processor, computer processor, central processing unit (CPU), and computer are used synonymously to denote a device capable of executing the instructions and communicating with input/output interfaces and/or peripheral devices, and that the terms processor, hardware processor, computer processor, CPU, and computer are intended to encompass single or multiple devices, single core and multicore devices, and variations thereof.

From the description herein, it will be appreciated that the present disclosure encompasses multiple embodiments which include, but are not limited to, the following:

1. An apparatus for managing energy within a plug-in hybrid electric vehicle (PHEV), comprising: (a) a plug-in hybrid electric vehicle (PHEV), as a vehicle comprising a fuel burning engine, at least one electric motor, a clutch coupling between said fuel burning engine and said at least one electric motor, a battery system for storing electric energy, a drive transmission for coupling mechanical output from the fuel burning engine and/or said at least one electric motor to a drivetrain, and wherein power requested for vehicle motion is supplied by a combination of said fuel burning engine and said at least one electric motor driven from stored electric energy in said battery system; (b) a processor configured for controlling power use on said vehicle; and (c) a non-transitory memory storing instructions executable by the processor; (d) wherein said instructions, when executed by the processor, execute a data driven supervisory energy management system (EMS) which performs one or more steps comprising: (d)(i) executing automated driving training which trains a prediction process for said vehicle motion trajectories based on historical vehicle trip data including vehicle speed, preceding vehicle speed and relative distance, as well as sensor information about vehicle state and environmental state, wherein said automated driving training is configured for outputting environmental prediction parameters; (d)(ii) executing automated powertrain control training which trains a parametric approximation of a cost function to reach a destination in response to historical trip data, and cloud-based traffic data, as well as information about vehicle and powertrain state, wherein said parametric approximation provides long-term estimations about the remainder of a given trip of said vehicle as trip energy cost parameters; (d)(iii) executing an automated driving system for said vehicle which utilizes said environmental prediction parameters, information about vehicle and environmental state, and forecasts of power allocation for planning an estimated trajectory while avoiding energy-wasteful behaviors; and (d)(iv) executing a powertrain control system which is configured for outputting forecasts of power allocation based on trip energy cost parameters, information about the PHEV vehicle and its powertrain state, and for controlling torque of said fuel burning engine and at least one electric motor, as well as for controlling powertrain mode.

2. A non-transitory medium storing instructions executable by a processor of a plug-in hybrid electric vehicle (PHEV), said instructions when executed by the processor performing steps comprising: (a) executing automated driving training which trains a prediction algorithm for vehicle motion trajectories based on historical vehicle trip data including vehicle speed, preceding vehicle speed and relative distance, as well as sensor information about vehicle and environmental state, wherein said automated driving training is configured for outputting environmental prediction parameters; (b) executing automated powertrain control training which trains a parametric approximation of a cost function to reach a destination in response to historical trip data, and cloud traffic data, as well as information about vehicle and powertrain state, wherein said parametric approximation provides long-term estimations about the remainder of a given trip of said vehicle as trip energy cost parameters; (c) executing an automated driving system which utilizes said environmental prediction parameters, information about vehicle and environmental state, and forecasts of power allocation for planning an estimated trajectory while avoiding energy-wasteful behaviors; and (d) executing a powertrain control system which is configured for outputting forecasts of power allocation based on trip energy cost parameters, information about vehicle and powertrain state, and for controlling torque of vehicles fuel burning engine and at least one electric motor of said vehicle, as well as for controlling mode of a powertrain in said vehicle.

3. A method for managing energy within a plug-in hybrid electric vehicle (PHEV), the method comprising: (a) executing automated driving training of a plug-in hybrid electric vehicle (PHEV), as the vehicle, wherein said automated driving training trains a prediction process for vehicle motion trajectories based on historical vehicle trip data including vehicle speed, preceding vehicle speed and relative distance, as well as sensor information about vehicle and environmental state, wherein said automated driving training is configured for outputting environmental prediction parameters; (b) executing automated powertrain control training which trains a parametric approximation of a cost function to reach a destination in response to historical trip data and cloud traffic data, as well as information about vehicle and powertrain state, wherein said parametric approximation provides long-term estimations about a remainder of a given trip of said vehicle as trip energy cost parameters; (c) executing an automated driving system which utilizes said environmental prediction parameters, information about vehicle and environmental state, and forecasts of power allocation for planning an estimated trajectory while avoiding energy-wasteful behaviors; (d) executing a powertrain control system which is configured for outputting forecasts of power allocation based on trip energy cost parameters, information about vehicle and powertrain state, and for controlling torque of said fuel burning engine and at least one electric motor, as well as for controlling powertrain mode; and (e) wherein said method is performed by a processor executing instructions stored on a non-transitory medium within a plug-in hybrid electric vehicle.

4. The system, apparatus, medium or method of any preceding embodiment, wherein said instructions when executed by the processor further perform steps comprising interacting with internet cloud operations configured for performing said automated driving training offline.

5. The system, apparatus, medium or method of any preceding embodiment, wherein said automated driving training is performed by storing velocity trajectories of said vehicle and of preceding vehicles onto the internet cloud, with cloud computing performed in response to a set of logged trip data for training a non-linear autoregressive recurrent neural network using stochastic gradient descent back propagation, with said non-linear autoregressive recurrent neural network being updated prior to or at the beginning of teach trip of the vehicle.

6. The system, apparatus, medium or method of any preceding embodiment, wherein said automated powertrain control training is performed in combination with utilizing offline internet cloud operations.

7. The system, apparatus, medium or method of any preceding embodiment, wherein said instructions when executed by the processor perform said environment prediction during said automated driving training in response to utilizing velocity prediction of preceding vehicles.

8. The system, apparatus, medium or method of any preceding embodiment, wherein said instructions when executed by the processor perform said velocity prediction in response to utilizing of an equally spaced discrete time series, where prediction at each time step affects the subsequent predictions.

9. The system, apparatus, medium or method of any preceding embodiment, wherein said instructions when executed by the processor executing said automated driving system is configured for identifying energy-wasteful behaviors selected from a group of energy wasteful behaviors consisting of undue braking, excessive acceleration, and suboptimal energy management.

10. The system, apparatus, medium or method of any preceding embodiment, wherein said instructions when executed by the processor perform executing of said powertrain control system in response to utilizing model predictive control for solving a minimization estimation at each time step in response to receiving information comprising battery internal state of charge, engine torque, motor torque, clutch state, wheel speed, wheel torque, a cost function relating a weight sum of fuel power and internal power, state dynamics, and limitations of said vehicle systems.

11. The system, apparatus, medium or method of any preceding embodiment, wherein said vehicle is instrumented for at least level 1 automated driving.

12. The system, apparatus, medium or method of any preceding embodiment, wherein said instructions when executed by the processor further perform steps comprising: (a) obtaining route setting information for a trip from a user of said vehicle; (b) (b) obtaining a route from a routing process; (c) obtaining route-specific environmental prediction parameters and trip energy cost parameters; (d) prompting the user to commence a trip with said vehicle for which said route has been obtained; (e) performing a level of automated driving in response to the user selecting a level of automated driving; (f) running a powertrain control system; and (g) determining said vehicle has reached destination and collecting trip data for historical trip data processing.

13. The system, apparatus, medium or method of any preceding embodiment, wherein said instructions when executed by the processor perform obtaining of route-specific environmental prediction parameters and trip energy cost parameters, as well as performing historical trip data processing in cooperation of cloud computing.

As used herein, the singular terms “a,” “an,” and “the” may include plural referents unless the context clearly dictates otherwise. Reference to an object in the singular is not intended to mean “one and only one” unless explicitly so stated, but rather “one or more.”

As used herein, the term “set” refers to a collection of one or more objects. Thus, for example, a set of objects can include a single object or multiple objects.

As used herein, the terms “substantially” and “about” are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, “substantially” aligned can refer to a range of angular variation of less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

Although the description herein contains many details, these should not be construed as limiting the scope of the disclosure but as merely providing illustrations of some of the presently preferred embodiments. Therefore, it will be appreciated that the scope of the disclosure fully encompasses other embodiments which may become obvious to those skilled in the art.

References in this specification referring to “an embodiment”, “at least one embodiment” or similar embodiment wording indicates that a particular feature, structure, or characteristic described in connection with a described embodiment is included in at least one embodiment of the present disclosure. Thus, these various embodiment phrases are not necessarily all referring to the same embodiment, or to a specific embodiment which differs from all the other embodiments being described. The embodiment phrasing should be construed to mean that the particular features, structures, or characteristics of a given embodiment may be combined in any suitable manner in one or more embodiments of the disclosed apparatus, system or method.

All structural and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

What is claimed is:

1. An apparatus for managing energy within a plug-in hybrid electric vehicle (PHEV), comprising:
(a) a plug-in hybrid electric vehicle (PHEV), as a vehicle comprising a fuel burning engine, at least one electric motor, a clutch coupling between said fuel burning engine and said at least one electric motor, a battery system for storing electric energy, a drive transmission for coupling mechanical output from the fuel burning engine and/or said at least one electric motor to a drivetrain, and wherein power requested for vehicle motion is supplied by a combination of said fuel burning engine and said at least one electric motor driven from stored electric energy in said battery system;
(b) a processor configured for controlling power use on said vehicle; and
(c) a non-transitory memory storing instructions executable by the processor;
(d) wherein said instructions, when executed by the processor, execute a data driven supervisory energy management system (EMS) which performs one or more steps comprising:
(i) executing automated driving training which trains a prediction process for said vehicle motion trajectories based on historical vehicle trip data including vehicle speed, preceding vehicle speed and relative distance, as well as sensor information about vehicle state and environmental state, wherein said automated driving training is configured for outputting environmental prediction parameters;
(ii) executing automated powertrain control training which trains a parametric approximation of a cost function to reach a destination in response to historical trip data, and cloud-based traffic data, as well as information about vehicle and powertrain state, wherein said parametric approximation provides long-term estimations about the remainder of a given trip of said vehicle as trip energy cost parameters;
(iii) executing an automated driving system for said vehicle which utilizes said environmental prediction parameters, information about vehicle and environmental state, and forecasts of power allocation for planning an estimated trajectory while avoiding energy-wasteful behaviors; and
(iv) executing a powertrain control system which is configured for outputting forecasts of power allocation based on trip energy cost parameters, information about the PHEV vehicle and its powertrain state, and for controlling torque of said fuel burning engine and at least one electric motor, as well as for controlling powertrain mode.

2. The apparatus of claim 1, wherein said instructions when executed by the processor further perform steps comprising interacting with internet cloud operations configured for performing said automated driving training offline.

3. The apparatus of claim 2, wherein said automated driving training is performed by storing velocity trajectories of said vehicle and of preceding vehicles onto the internet cloud, with cloud computing performed in response to a set of logged trip data for training a non-linear autoregressive recurrent neural network using stochastic gradient descent back propagation, with said non-linear autoregressive recurrent neural network being updated prior to or at the beginning of teach trip of the vehicle.

4. The apparatus of claim 1, wherein said automated powertrain control training is performed in combination with utilizing offline internet cloud operations.

5. The apparatus of claim 1, wherein said instructions when executed by the processor perform said environment prediction during said automated driving training in response to utilizing velocity prediction of preceding vehicles.

6. The apparatus of claim 5, wherein said instructions when executed by the processor perform said velocity prediction in response to utilizing of an equally spaced discrete time series, where prediction at each time step affects the subsequent predictions.

7. The apparatus of claim 1, wherein said instructions when executed by the processor executing said automated driving system is configured for identifying energy-wasteful behaviors selected from a group of energy wasteful behaviors consisting of undue braking, excessive acceleration, and suboptimal energy management.

8. The apparatus of claim 1, wherein said instructions when executed by the processor perform executing of said powertrain control system in response to utilizing model predictive control for solving a minimization estimation at each time step in response to receiving information comprising battery internal state of charge, engine torque, motor torque, clutch state, wheel speed, wheel torque, a cost function relating a weight sum of fuel power and internal power, state dynamics, and limitations of said vehicle systems.

9. The apparatus of claim 1, wherein said vehicle is instrumented for at least level 1 automated driving.

10. The apparatus of claim 1, wherein said instructions when executed by the processor further perform steps comprising:
(a) obtaining route setting information for a trip from a user of said vehicle;
(b) obtaining a route from a routing process;
(c) obtaining route-specific environmental prediction parameters and trip energy cost parameters;
(d) prompting the user to commence a trip with said vehicle for which said route has been obtained;
(e) performing a level of automated driving in response to the user selecting a level of automated driving;
(f) running a powertrain control system; and
(g) determining said vehicle has reached destination and collecting trip data for historical trip data processing.

11. The apparatus of claim 10, wherein said instructions when executed by the processor perform obtaining of route-specific environmental prediction parameters and trip energy cost parameters, as well as performing historical trip data processing in cooperation of cloud computing.

12. A non-transitory medium storing instructions executable by a processor of a plug-in hybrid electric vehicle (PHEV), said instructions when executed by the processor performing steps comprising:
(a) executing automated driving training which trains a prediction algorithm for vehicle motion trajectories based on historical vehicle trip data including vehicle speed, preceding vehicle speed and relative distance, as well as sensor information about vehicle and environmental state, wherein said automated driving training is configured for outputting environmental prediction parameters;
(b) executing automated powertrain control training which trains a parametric approximation of a cost function to reach a destination in response to historical trip data, and cloud traffic data, as well as information about vehicle and powertrain state, wherein said parametric approximation provides long-term estimations about the remainder of a given trip of said vehicle as trip energy cost parameters;
(c) executing an automated driving system which utilizes said environmental prediction parameters, information about vehicle and environmental state, and forecasts of power allocation for planning an estimated trajectory while avoiding energy-wasteful behaviors; and
(d) executing a powertrain control system which is configured for outputting forecasts of power allocation based on trip energy cost parameters, information about vehicle and powertrain state, and for controlling torque of vehicles fuel burning engine and at least one electric motor of said vehicle, as well as for controlling mode of a powertrain in said vehicle.

13. A method for managing energy within a plug-in hybrid electric vehicle (PHEV), the method comprising:
(a) executing automated driving training of a plug-in hybrid electric vehicle (PHEV), as the vehicle, wherein said automated driving training trains a prediction process for vehicle motion trajectories based on historical vehicle trip data including vehicle speed, preceding vehicle speed and relative distance, as well as sensor information about vehicle and environmental state, wherein said automated driving training is configured for outputting environmental prediction parameters;
(b) executing automated powertrain control training which trains a parametric approximation of a cost function to reach a destination in response to historical trip data and cloud traffic data, as well as information about vehicle and powertrain state, wherein said parametric approximation provides long-term estimations about a remainder of a given trip of said vehicle as trip energy cost parameters;
(c) executing an automated driving system which utilizes said environmental prediction parameters, information about vehicle and environmental state, and forecasts of power allocation for planning an estimated trajectory while avoiding energy-wasteful behaviors;
(d) executing a powertrain control system which is configured for outputting forecasts of power allocation based on trip energy cost parameters, information about vehicle and powertrain state, and for controlling torque of said fuel burning engine and at least one electric motor, as well as for controlling powertrain mode; and
(e) wherein said method is performed by a processor executing instructions stored on a non-transitory medium within a plug-in hybrid electric vehicle.
